(19) United States
(12) Patent Application Publication
(10) Pub. No.: US 2011/0231199 A1
(43) Pub. Date: Sep. 22, 2011

(54) Methods and Systems for Internet-Based Network Shareholder Electronic Voting Rights Reassignment

(76) Inventor: Argus I. Cunningham, Naples (IT)

(21) Appl. No.: 13/050,114

(22) Filed: Mar. 17, 2011

Related U.S. Application Data
(63) Continuation-in-part of application No. 13/019,038, filed on Feb. 1, 2011.
(60) Provisional application No. 61/315,299, filed on Mar. 18, 2010.

(51) Int. Cl. G06Q 10/00

(52) U.S. Cl. 705/1.1

(57) ABSTRACT

Network member corporate stock shareholders or shareholder representatives voluntary impart and/or accept actual voting rights concerning shares owned by themselves and/or other Network members. This is accomplished by the existence of an Internet accessible server with a hosted memory store and software applications that implement and facilitate the re-assignment and recording of voting rights transferred from one Network member verified authorized party to another Network member verified party.

### CROSS-REFERENCE TO RELATED APPLICATIONS

This application relates to U.S. provisional patent application entitled “Process for Internet-Based Network Shareholder Electronic Voting Rights Reassignment,” Ser. No. 61/315299, filed Mar. 18, 2010, and is a continuation-in-part of, claims priority from and the benefit of co-pending. U.S. utility application Ser. No. 13/019,038, filed Feb. 1, 2011, by the same inventor and entitled “Methods And Systems For Internet-Based Network Shareholder Communication, Voting, And The Creation Of Regulatory Compliant Shareholder Proposals”, the disclosure of each of which is incorporated herein by reference as if set forth in full.

### TECHNICAL FIELD

This disclosure relates generally to business methods and technology to implement the methods and more particularly to a methods and systems for internet-based electronic voting rights reassignment and server-hosted shareholder software applications to implement the methods.

### BACKGROUND

The present disclosure relates to a Network member accessible internet server based process of reassigning shareholder voting rights from a verified shareholder to other verified shareholders. It allows individual investors to utilize each other. The ability to share and delegate voting responsibilities between fellow shareholders allows currently inactive investors to efficiently take part in corporate governance activities.

The reassignment of voting rights already occurs in the investment arena. Brokerages have often voted shares held in “street name” by actual shareholders. Institutional Investors often sub-contract voting duties to professional proxy firms. The present inventor surmises that this occurs for several reasons. At the individual level, although previous legislation has made it harder for brokerages to exercise the voting rights of their clients, substantial obstacles still exist for the individual investor. An investor owning 10 companies who each have 8 directors would have to be knowledgeable about 80 candidates for each proxy season. This can be a daunting and time-consuming task. Individual Investors often simply “opt out” and do not participate. Institutional funds that have even more voting evolutions and resources often obtain the services of professional proxy firms who conduct these activities on their behalf. This is not an optimal situation because the brokerage, or contracted proxy service do not actually own the shares for which they are exercising voting rights.

Furthermore, brokerages may have other interests that directly conflict with best interests of shareholders. The ability of brokerages or other brokerage members to essentially bet against a corporation through direct short selling or the lending of member shares for the use of short selling or option puts establishes a position that is misaligned with corporate success. Essentially, how can a brokerage maintain or allow a “short” position and at the same time vote in a manner that would ensure corporate success? The existence of this basic conflict of interest would seem to conflict with optimum shareholder governorship acting in the interest of all shareholders.

One may also make the case that institutional funds are unable to enact good shareholder governorship. This may be due to the fact these funds may have positions in hundreds or even thousands of individual corporations. Is it possible for any mutual fund manager to be optimally informed and in a position to make the best voting decision given the sheer numbers of corporations in which they maintain voting interests? The existence of proxy service firms that fulfill this function would denote that fund managers cannot and thus would often prefer to outsource that function. Proxy service firms may attempt to accomplish this, but as non-owners, are they really in the best position to serve aligned interests to actual owners? The inventor surmises that they are not and a fund manager would be better served by transferring those voting rights to other shareholders who have skin in the game. In doing so, the fund manager would ensure that only actual owners are voting on behalf of other owners.

### SUMMARY

Network member corporate stock shareholders or shareholder representatives voluntary impart and/or accept both virtual and actual voting rights concerning shares owned by themselves and/or other network members. This is accomplished by the existence of an Internet accessible server with a hosted memory store and software applications that implement and facilitate the re-assignment and recording of voting rights transferred from one network member verified authorized party to another Network member verified party.

The user is automatically verified and matched to a member database according to previously entered verification information. The verified user will have the option to re-assign votes only for the corporations of which the user owns actual shares. The software verifies ownership in a concerned company by searching for previously input holdings data by the member. Once the search process confirms the user does indeed own the concerned stock, the application and system to re-assign their individual voting right to another member is presented to the user through a computer interface.

An electronic template automatically drafts, hosts, and records documents that are capable of legally transferring voting rights from one shareholder to another. Information is at least partially filled in automatically by the software with pertinent data sourced from a database including, names, addresses, amount of shares with voting rights to be transferred, and any other legal information required for the transfer.

Once the template is complete, the authorizing member may digitally sign the instrument. After signature, the completed instrument is electronically sent to relevant parties, which may include but are not limited to the brokerage holding the shares, the corporation involved, and the assignee of the voting rights. The purpose of the electronic correspondence is to notify all pertinent parties that voting rights have been legally transferred.

The software recognizes the agreement and transfers incoming proxies accordingly. Additionally, the system recognizes “revocation” events and rescinds the agreement if necessary or requested.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a diagrammatic illustration of an exemplary embodiment of an internet browser portal user interface of the present disclosure.

FIG. 2 is a diagrammatic illustration of an exemplary embodiment of a voting rights reassignment application user interface of the present disclosure.

FIG. 3 is a diagrammatic illustration of an exemplary embodiment of a voting rights reassignment collaborator menu of the present disclosure.

FIG. 4 is a diagrammatic illustration of an exemplary embodiment of an internet browser user interface profile page of the present disclosure with a collaborator tab open.

FIG. 5 is a diagrammatic illustration of an exemplary embodiment of a voting rights reassignment member menu of the present disclosure.

FIG. 6 is a diagrammatic illustration of an exemplary embodiment of an internet browser user interface profile page of the present disclosure with a “listening to” tab open.

FIG. 7 is a diagrammatic illustration of an exemplary embodiment of a voting rights reassignment member listener menu of the present disclosure.

FIG. 8 is a diagrammatic illustration of an exemplary embodiment of an internet browser user interface profile page of the present disclosure with a listeners tab open.

FIG. 9 is a diagrammatic illustration of an exemplary embodiment of a voting rights reassignment member search menu of the present disclosure.

FIG. 10 is a diagrammatic illustration of an exemplary embodiment of a voting rights reassignment member search menu of the present disclosure with search results.

FIG. 11 is a diagrammatic illustration of an exemplary embodiment of a voting rights reassignment member search menu of the present disclosure with search results selected.

FIG. 12 is a diagrammatic illustration of an exemplary embodiment of a voting rights reassignment transfer agreement user interface of the present disclosure.

FIG. 13 is a diagrammatic illustration of an exemplary embodiment of a voting rights reassignment transfer agreement user interface of FIG. 12.

FIG. 14 is a diagrammatic illustration of an exemplary embodiment of a voting rights reassignment transfer agreement user interface of FIG. 13 confirmation notice.

FIG. 15 is a diagrammatic illustration of an exemplary embodiment of a vote record display of the present disclosure.

FIG. 16 is a diagrammatic illustration of an exemplary embodiment of an internet browser user interface dashboard of the present disclosure.

FIG. 17 is a diagrammatic illustration of an exemplary embodiment of an internet browser user interface for messages of the present disclosure.

FIG. 18 is a diagrammatic illustration of an exemplary embodiment of an internet browser user interface for messages of the present disclosure showing a message for a voting reassignment agreement.

FIG. 19 is a diagrammatic illustration of an exemplary embodiment of an internet browser user interface profile page of the present disclosure.

FIG. 20 is a diagrammatic illustration of an exemplary embodiment of a voting rights reassignment offer user interface of the present disclosure.

FIG. 21 is a diagrammatic illustration of an exemplary embodiment of an internet browser user interface for messages of the present disclosure showing a message for a voting reassignment agreement.

FIG. 22 is a diagrammatic illustration of an exemplary embodiment of an internet browser voting rights reassignment status page of the present disclosure.

FIG. 23 is a diagrammatic map of FIGS. 23A-23D, each of which is a quadrant of a process flow chart of a voting rights reassignment method of the present disclosure.

FIG. 23A is a schematic process flow chart of a voting rights reassignment initiation method of the upper left quadrant of FIG. 23.

FIG. 23B is a continuation of the schematic process flow chart of a voting rights reassignment initiation method of the upper right quadrant of FIG. 23.

FIG. 23C is a schematic process flow chart of a voting rights reassignment finalization method and proxy distribution of the lower right quadrant of FIG. 23.

FIG. 23D is a schematic process flow chart of a voting rights reassignment revocation method of the lower left quadrant of FIG. 23.

### DETAILED DESCRIPTION

The present disclosure, provides a system that includes without limitation a website hosted on at least one server connected to the World Wide Web/ sometimes also referred to herein as the Internet, and a Network of shareholder website members, wherein at least one server hosting the website comprises a processor and a computer readable memory unit coupled to the processor, said memory unit containing program code configured to be executed by the processor to implement the methods for shareholder voting rights reassignment herein described. It will be understood that when this disclosure refers to actions or input by a user of the system, such as by an initiating member or a recipient member, that the software applications are accepting and processing such user input. For the purposes of this disclosure the terms “company” and “corporation” are used interchangeably. The term “Network” as used herein shall be used to refer the online community of members to distinguish the term from, for example, a telecommunications network.

The steps of the present methods for assigning, retracting, and recording the transfer of voting rights are implemented electronically, in specific preferred embodiments, with one ore more computer connected to the Internet and running software that includes applications or “apps” to execute the steps. A system of the present disclosure includes without limitation, one or more internet accessible databases containing the applicable personal details regarding a plurality of shareholder Network members, a computer-based login process that matches the shareholder to the database server, a memory store coupled to a processor that executes (1) a first software application configured to identify owners and facilitate voting transfer process initiation by any member who is an owner or owner representative of the concerned corporation identified in the process, (2) a software application code that presents the option to transfer voting rights from a member owner to another member owner, (3) a third software application that allows the retraction of said transfer based upon member voluntary retraction or sale of the shares, (4) a fourth software application that records all transfers, (5), a fifth software application providing a search function allowing the search and display of previous archived voting transfer/retraction transactions from a data base archive in memory of all voting transfers, and (6) A sixth software application that recognizes the proxies by corporation, references agreements by members and ticker symbol, then electronically distributes these proxies automatically.

The system utilizes name and password information previously established to access the databases and the system software.

The system verifies that the process initiator does indeed own the stock based on holdings information entered into the server memory database by the member or electronically obtained from a brokerage or other information source. The time of data entrance will be recorded by the database. The process only allows owners of the stock the option of transferring the voting rights for owned shares in the concerned corporation. The software recognizes ownership and allows only current owners to access the application.

The initiator selects a potential candidate from a list and member information. The initiator optionally selects a candidate when presented with this information.

The system searches the Network database and verifies that the candidate does own the concerned stock utilizing the stock ticker symbol as reference data.

A notification process notifies the member/initiator that he/she is not eligible to access this application if ownership of the concerned stock is not verified.

The system provides displays and user interfaces that allow the initiating member (sometimes also referred to herein as the process initiator) to locate, identify and contact a potential transfer candidate. The identified candidate's ownership of the concerned stock is verified. The identified candidate makes an optional selection regarding the decision.

A search function allows the initiating member to find and proposition other members on the Network.

The system verifies that the Network member owner transferee does indeed own the stock based oh previous holdings information established and stored in the server.

An electronic voluntary option is presented to the concerned transferee that allows that member to accept, deny, or ignore the transfer voting rights presented by the process initiator.

The process-initiating member is notified of the potential transferee's election to accept, deny, or if the time duration limit of the agreement is exceeded. The duration time limit is established at, for example, 14 days.

If the transferee denies the option the voting rights transfer process is terminated.

If the transferee accepts the transfer of voting rights, the initiator is presented with the transfer document template and the option to digitally sign the created electronic document which will officially transfer the voting rights to the recipient Network member.

In a system of the present disclosure, a document generation, storage, and proxy distribution function is initiated when a selected member who also owns the stock accepts the proposal. When utilized, the software creates a dual party instrument that identifies the Network member transferor and the transferee identified in the voting right transfer process and allows the option of transferring voting rights concerning a corporation. The system recognizes the transfer of voting rights and will re-distribute any electronically received proxies according to the agreement instructions. The system recognizes the sum of voting shares transferred and identifies certain thresholds where additional notifications are triggered. When this occurs the software automatically notifies parties, which may include but are not limited to the corporation, all Network member owners of the concerned stock, the Securities and Exchange Commission, the transferee, and the member receiving the votes.

The system drafts and stores the drafted document, then emails said document to concerned parties identified by the initiator, the Network administrator, and the transferee or the concerned corporation.

The system records the transfer parties, time of transfer, time of revocation, and the amount of shares with voting rights transferred or revoked utilizing the concerned corporation ticker symbol as reference data.

The system displays real time transfer/revocation data concerning the concerned corporation accessible by Network members who also own the concerned stock

A server hosted data base search system is provided that allows Network members or administrators to indentify previous voting transfer/revocation transactions between Network members by search function that identifies members, corporations, times, and share amounts.

The system identifies when the voting power of any member exceeds a certain percentage of the total outstanding shares of the stock of the concerned corporation.

The system calculates total voting power of the member where the total is defined by individually owned shares voting rights and assigned voting rights by utilizing previously input holdings data by the receiving member and assigned voting power imparted by fellow Network member shareholders.

The total share sum voting power of the member is divided by the total number of outstanding shares issued by the concerned corporation, multiplied by 100, and then rounded off to the fourth decimal. If final, product percentage number of shares exceeds a predetermined amount the notification process commences.

The transmission of proxies by corporations or brokerages is recognized, and then electronically routed to the member who has been assigned voting rights.

The system allows the revocation of voting rights upon voluntary initiation by the individual Network member owner who previously assigned voting rights to another member or the Network member recipient of those voting rights. Additionally, revocation of those voting rights will occur upon the sale of the concerned stock by the individual Network member owner who originally transferred the voting fights or by the assignee who received the stock. Voting rights and the transfer of these rights may only exist between two Network members who currently own the stock. A complete divesture of the concerned stock by either party nullifies the transfer.

Revocation is initiated when the original Network member transferee revokes the transfer of voting rights. The initiator is presented with the revocation document template and the option to digitally sign the created electronic document to officially revoke the voting rights previously assigned to the concerned recipient Network member.

Revocation is initiated if the original transferring Network member owner of the concerned corporation sells the stock as indicated by a change in holding data reflected in the member's holdings data present on the database. The application automatically generates an electronic notification document which will officially revoke the voting rights previously assigned to the concerned recipient Network member.

Revocation is initiated if the Network member owner who received the transferred votes of shares of the concerned corporation sells the stock as indicated by a change in holdings data reflected in the member's holdings data database. The application automatically generates an electronic notification document which officially revokes the voting rights previously assigned to the concerned recipient Network member.

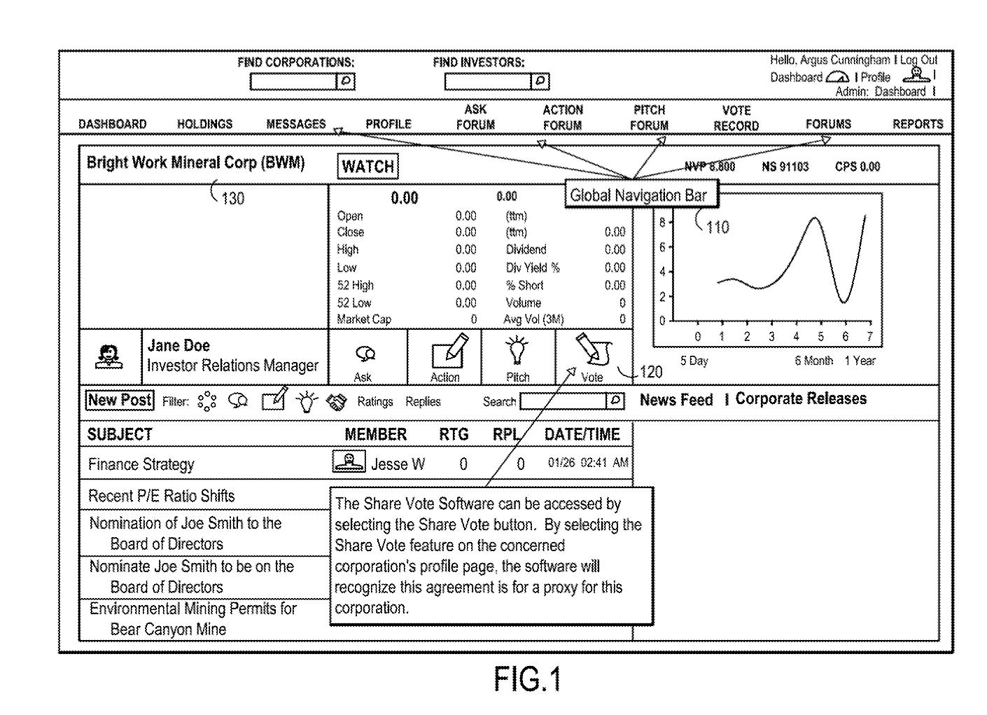

Turning now to the drawings and referring to FIG. 1, FIG. 1 is a diagrammatic illustration of an exemplary embodiment of an internet browser portal user interface of the present disclosure. Upon login, the portal grants access via the internet to a Network of members who own shares in public companies. Global Navigation Bar 110 provides, without limitation, tabs to a member dashboard, holdings, messages, profile, ask forum, action forum, pitch forum, vote record, forums and reports. A virtual button 120 is provided to initiate a voter reassignment process by launching the “Share Vote” software application. Voter reassignment is implemented for a particular company of which the member owns stock, such as Bright Work Mineral (BWM), identified in the upper left hand corner 130.

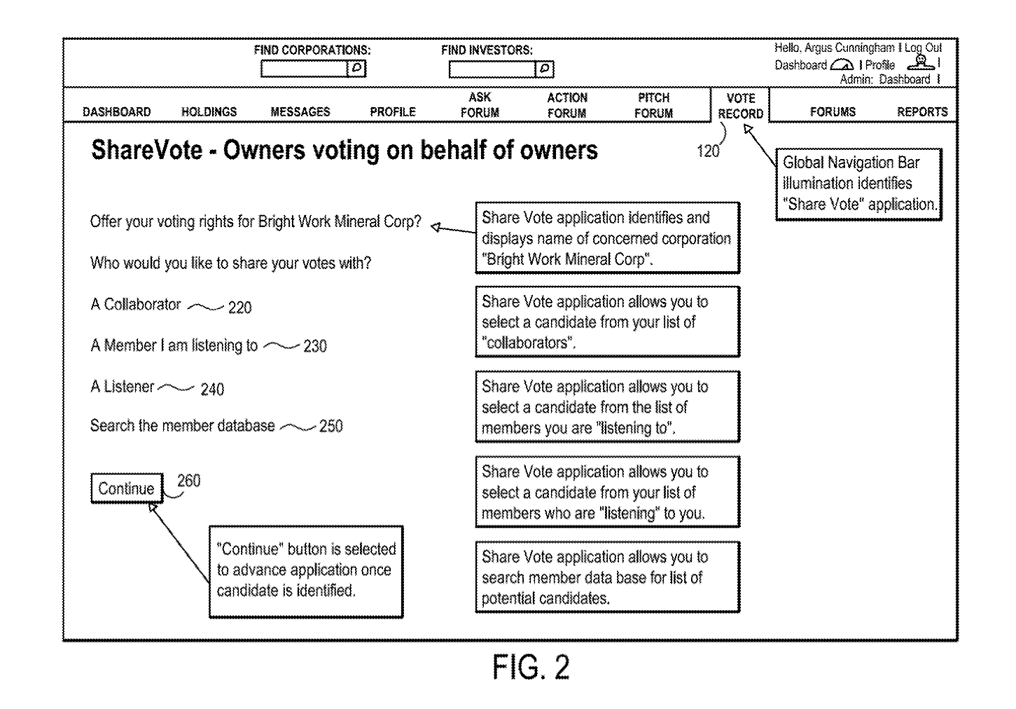

FIG. 2 is a diagrammatic illustration of an exemplary embodiment of a voting rights reassignment application user interface of the present disclosure. Activating tab Vote Record 210 on the Global Navigation Bar causes a menu to be displayed to begin the voter reassignment process. Concerning the BWM company, the software asks who the member would like share, or reassign, votes with, and provide for options for selection: A Collaborator 220; A Member that the user is listening to 230, someone the user listens to 240, or to search the database for a member 250. After making a selection, the member activates virtual button “continue” 260.

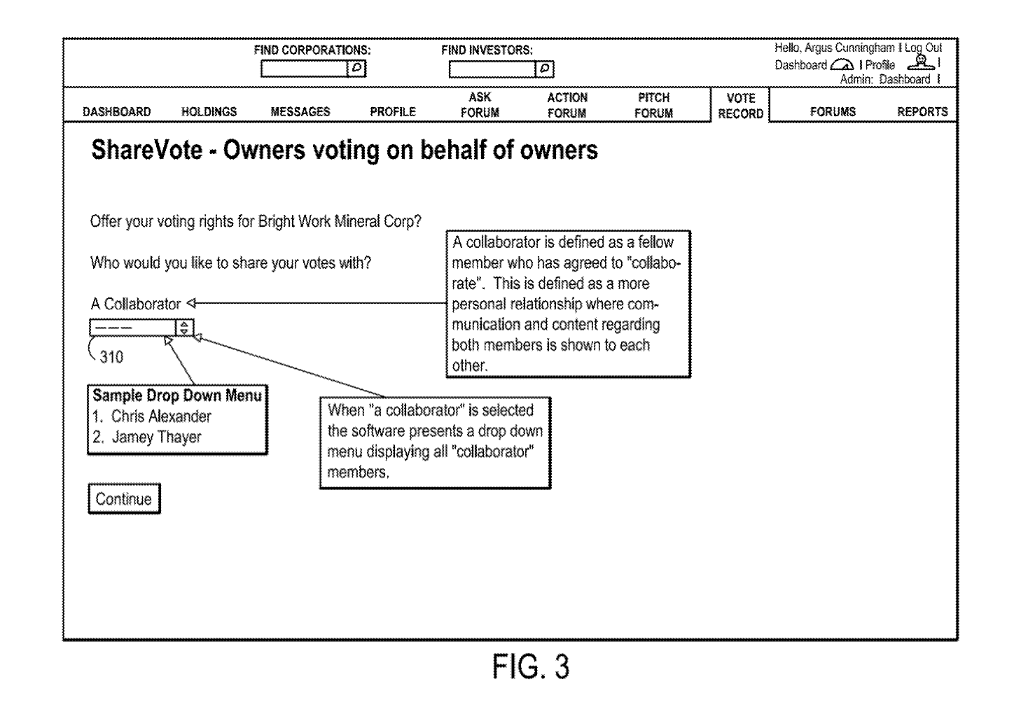

FIG. 3 is a diagrammatic illustration of an exemplary embodiment of a voting rights reassignment collaborator menu of the present disclosure. Selecting “A Collaborator” 220 opens a drop down menu 310 which lists the member's collaborators.

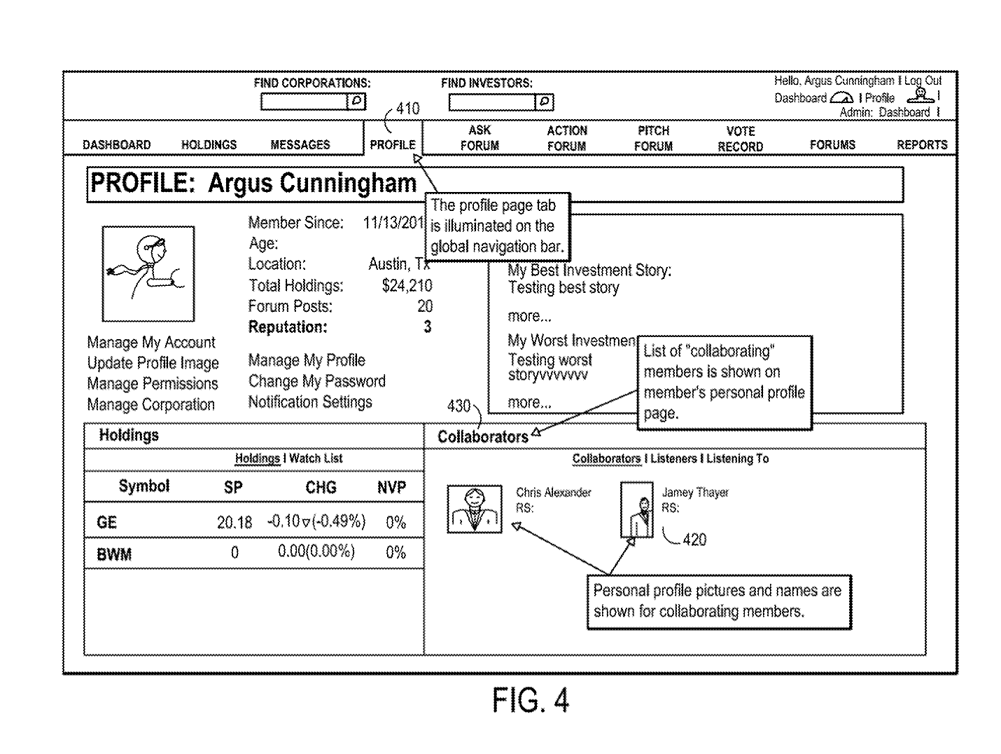

FIG. 4 is a diagrammatic illustration of an exemplary embodiment of an internet browser user interface profile page of the present disclosure with a collaborator tab open. Another way to display one's collaborators is to open the “Profile” tab 410 on the Global Navigation Bar to open one's member profile. The profile displays collaborators 420 in the collaborators frame 430.

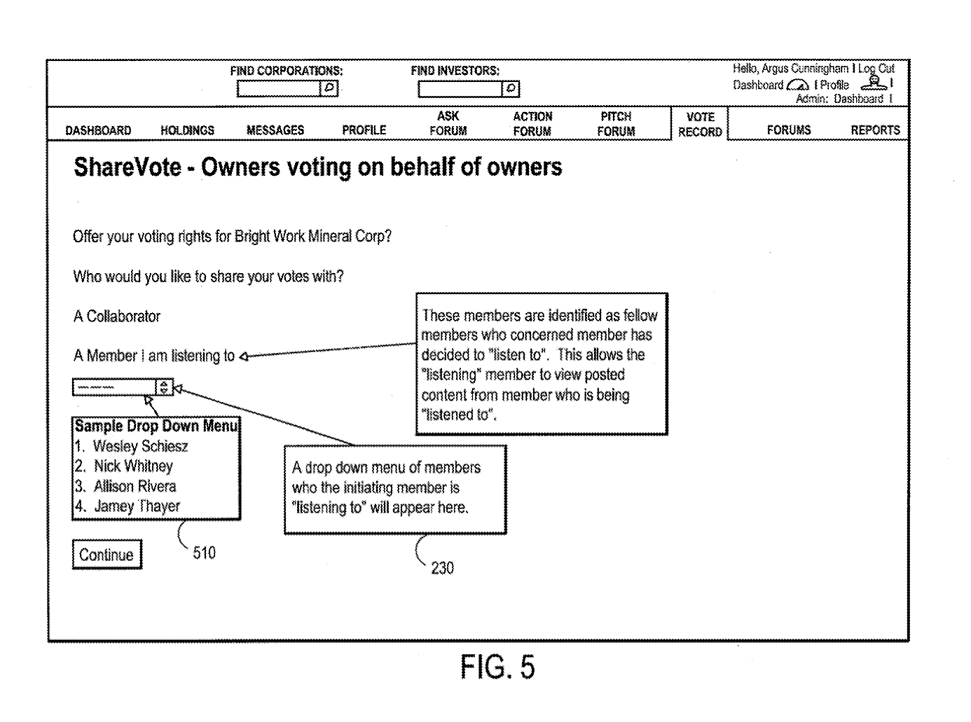

FIG. 5 is a diagrammatic illustration of an exemplary embodiment of a voting fights reassignment member menu of the present disclosure. Returning to the Share Vote menu of FIG. 2, selection of the option “A Member I am Listening to” 230 opens a drop down menu 510 of members that process initiator is listening to.

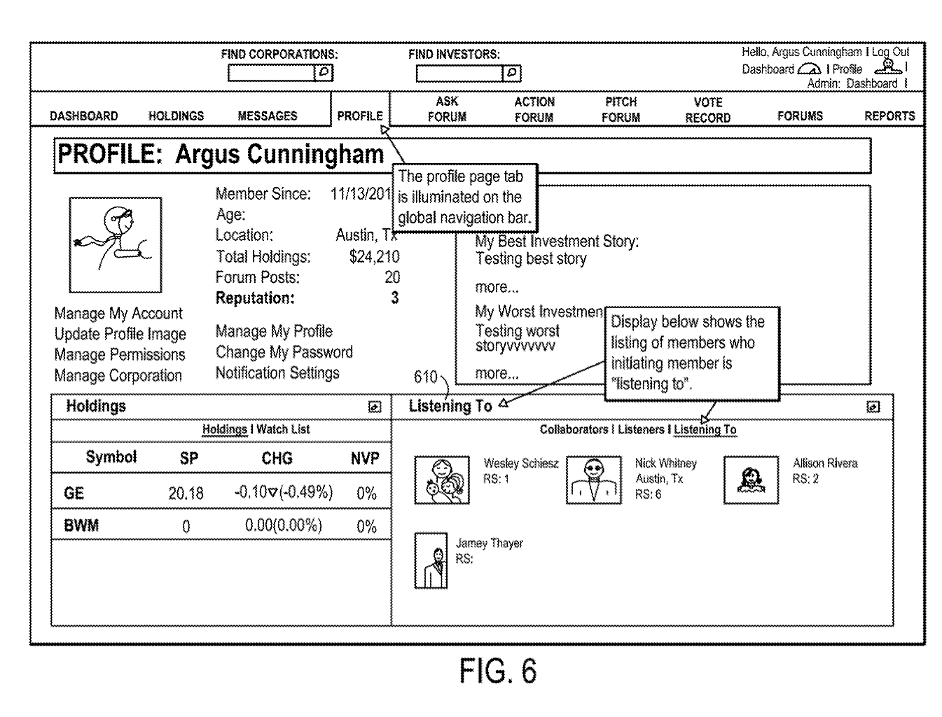

FIG. 6 is a diagrammatic illustration of an exemplary embodiment of an internet browser user interface profile page of the present disclosure with a “listening to” tab open. A member may see who he or she is listening to from the member's profile page in the “Listening To” frame 610.

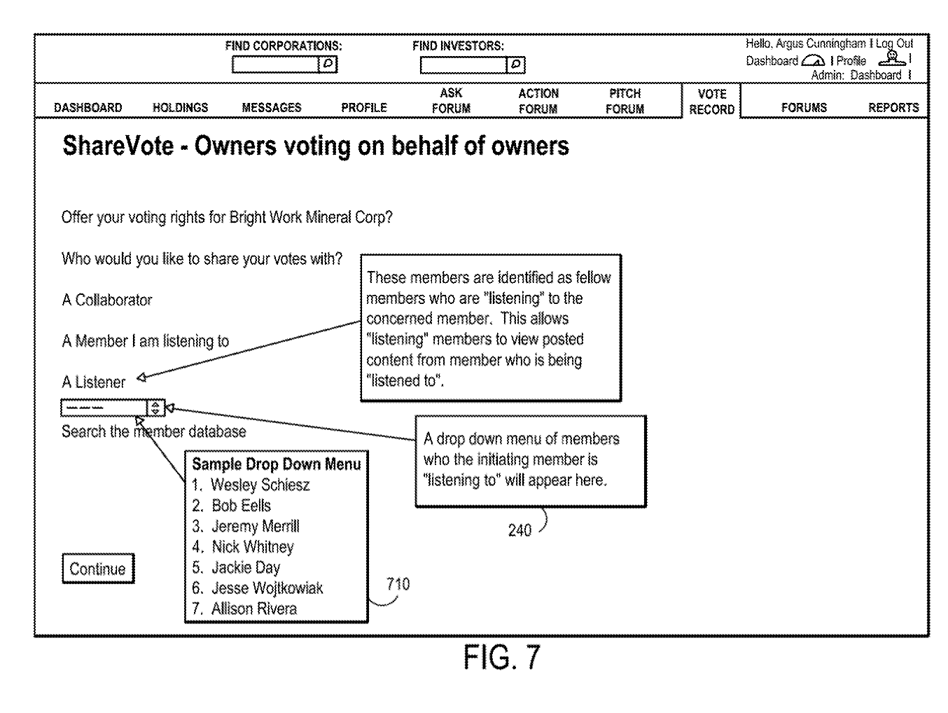

FIG. 7 is a diagrammatic illustration of an exemplary embodiment of a voting rights reassignment member listener menu of the present disclosure. Returning to the Share Vote menu of FIG. 2, selection of the option “A Listener” 240 opens a drop down menu 710 of member's that listen to the process initiator.

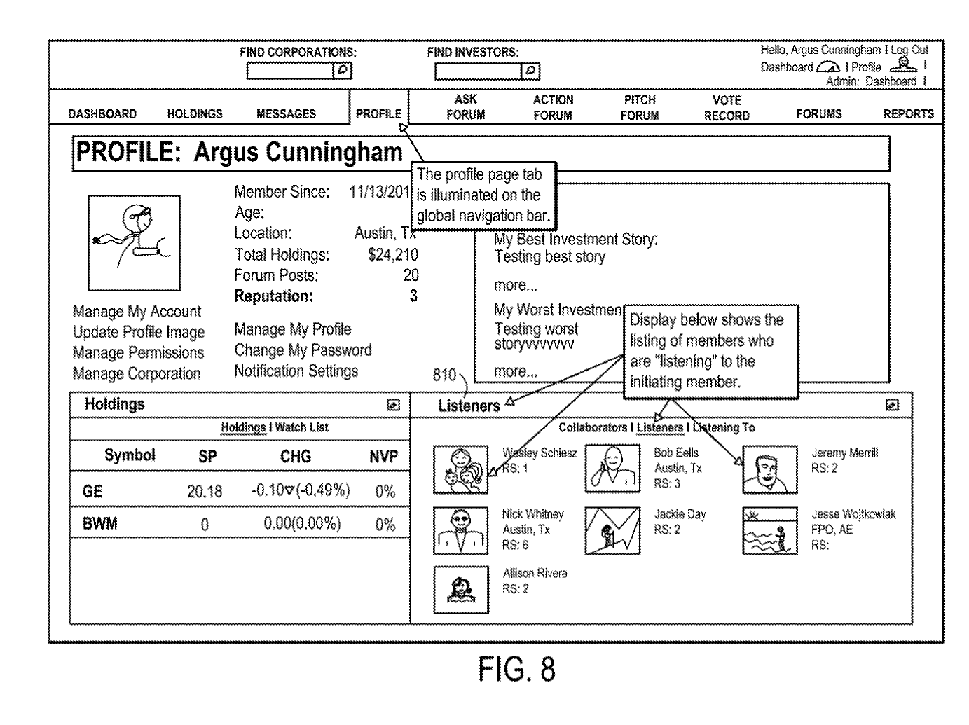

FIG. 8 is a diagrammatic illustration of an exemplary embodiment of an internet browser user interface profile page of the present disclosure with a listeners tab open. A member may see who he or she is listening to them from the member's profile page in the “Listeners” frame 810.

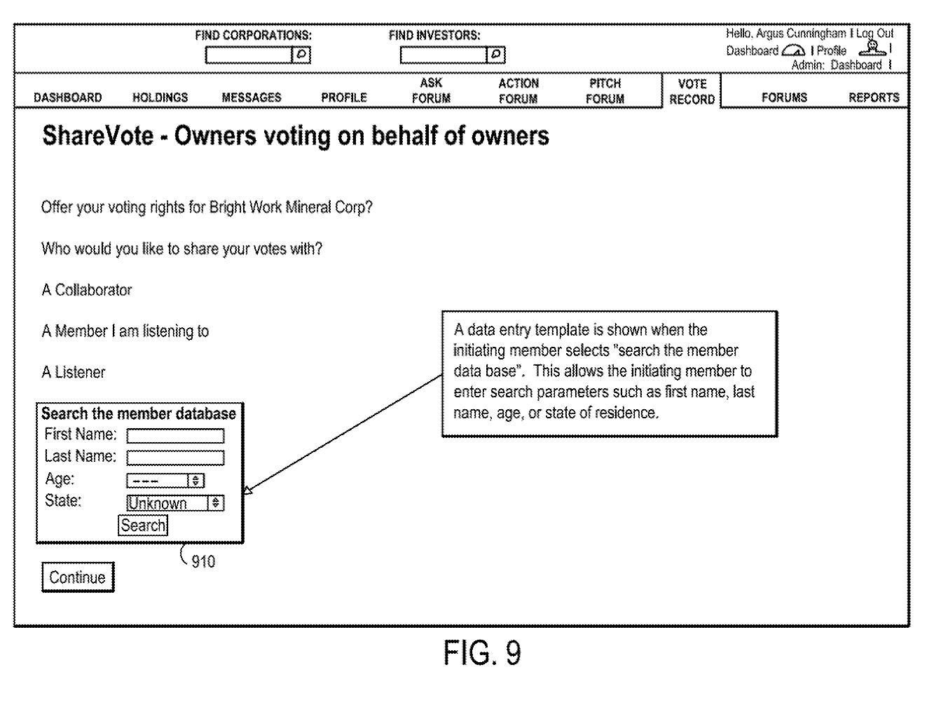

FIG. 9 is a diagrammatic illustration of an exemplary embodiment of a voting rights reassignment member search menu of the present disclosure. Returning to the Share Vote menu of FIG. 2, selection of the option “Search Member Database” 250 opens a search engine interface 910.

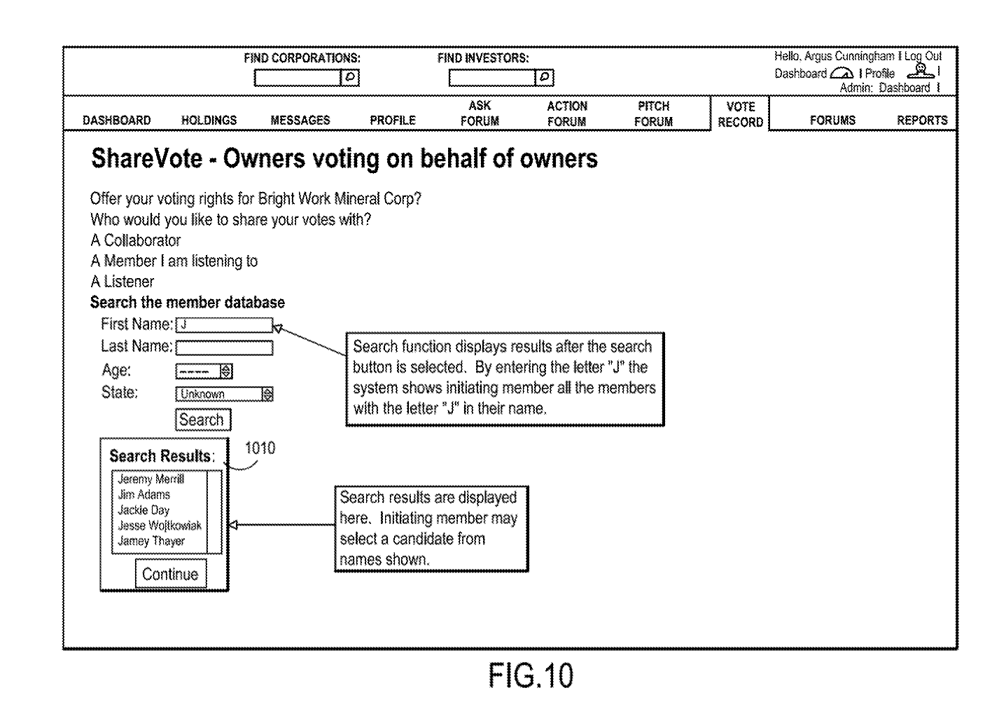

FIG. 10 is a diagrammatic illustration of an exemplary embodiment of a voting rights reassignment member search menu of the present disclosure with search results. In a preferred embodiment, search engine interface 910 has an autofill or smart search capability so that candidate member names arc displayed 1010 as search parameters are entered into the interface.

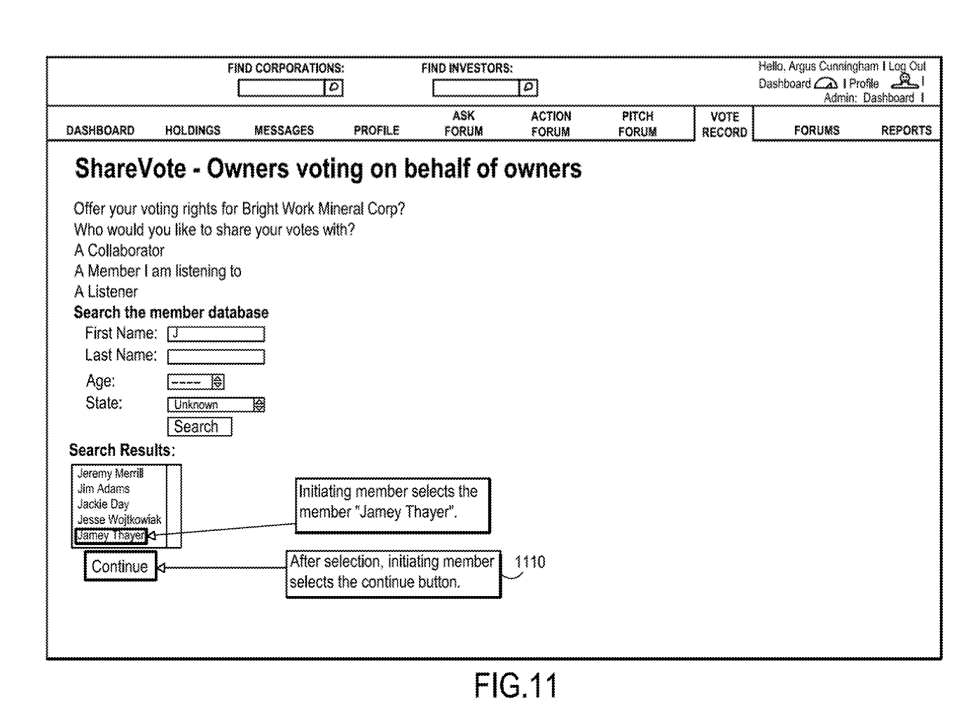

FIG. 11 is a diagrammatic illustration of an exemplary embodiment of a voting rights reassignment member search menu of the present disclosure with search results selected. Upon selection of a candidate member from the search results, the process initiator clicks the “continue” virtual button 1110 to advance to the next screen.

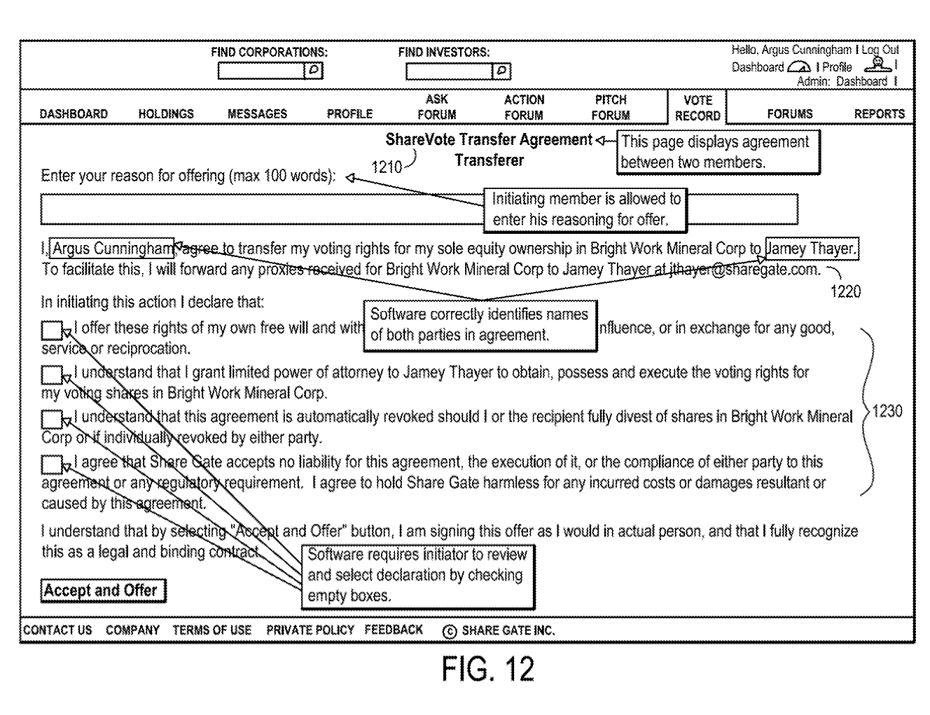

FIG. 12 is a diagrammatic illustration of an exemplary embodiment of a voting rights reassignment transfer agreement user interface of the present disclosure. Once a member has been selected with which to reassign or share voting rights, the two members enter into an agreement to reassign voting rights where the process initiator agrees to transfer voting rights to the selected member, and the selected members agrees to accept the transferred voting rights. The text of the agreement is automatically generated by the system software as a form agreement 1210 under the “Vote Record” tab of the Global Navigation Bar.

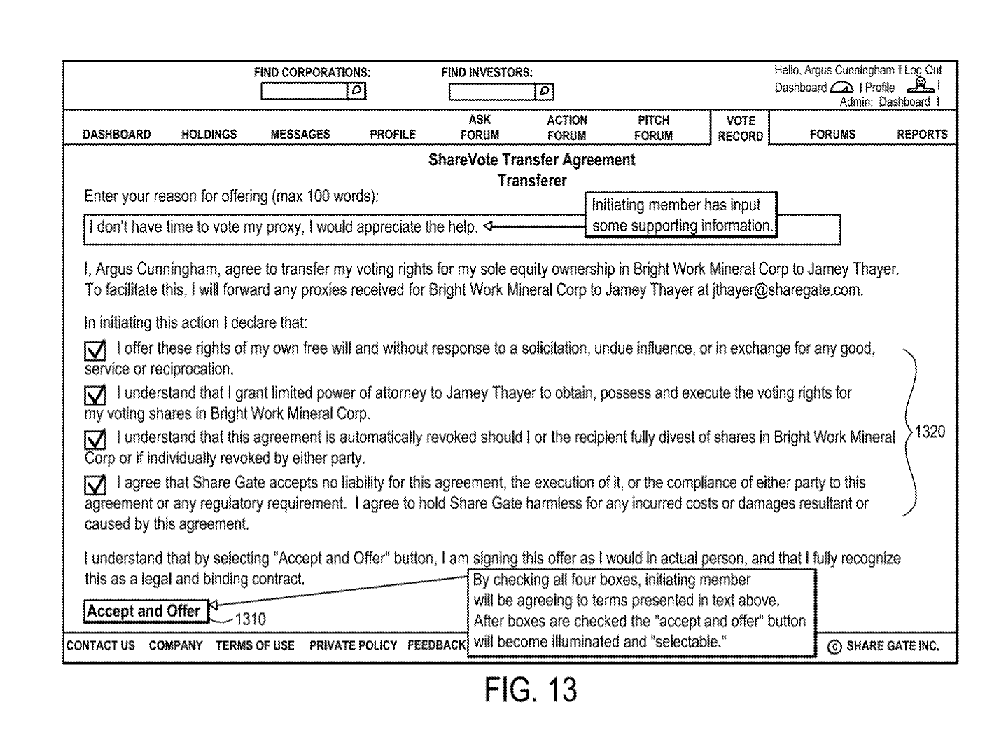

FIG. 13 is a diagrammatic illustration of an exemplary embodiment of a voting rights reassignment transfer agreement user interface of FIG. 12. Continuing with the completion of the Rights Transfer Agreement, one or more of the statements 1320 presented in the agreement are ticked by the process initiator, the offer to transfer rights is made by activating virtual button 1310 to communicate the offer to the selected member.

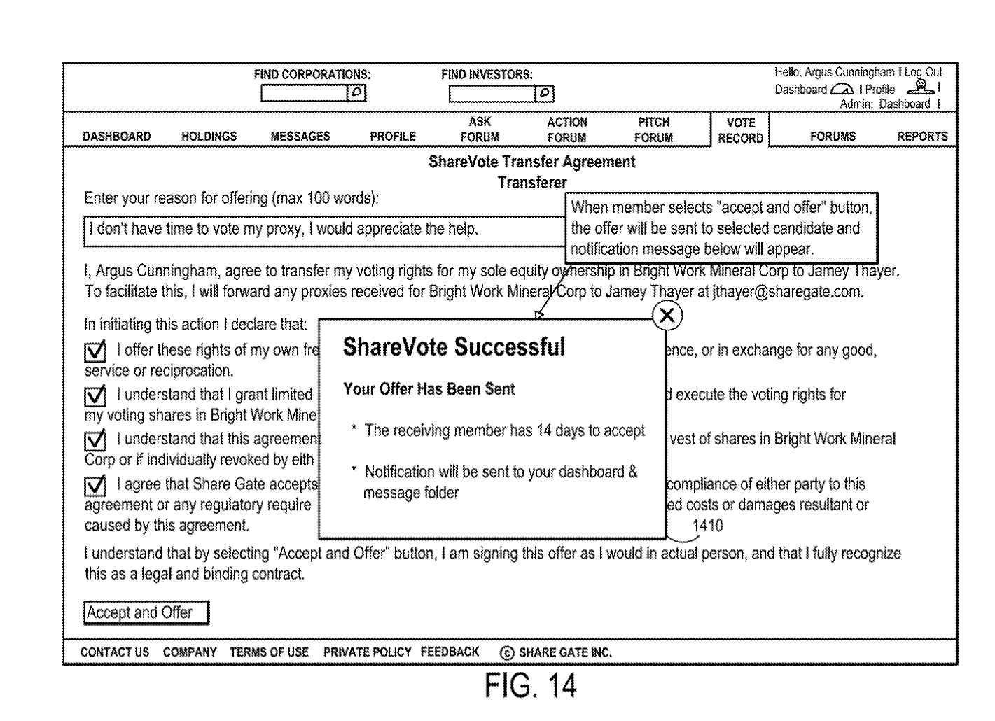

FIG. 14 is a diagrammatic illustration of an exemplary embodiment of a voting rights reassignment transfer agreement user interface of FIG. 13 confirmation notice. “Success” confirmation notice 1410 is displayed after activation of the button 1310.

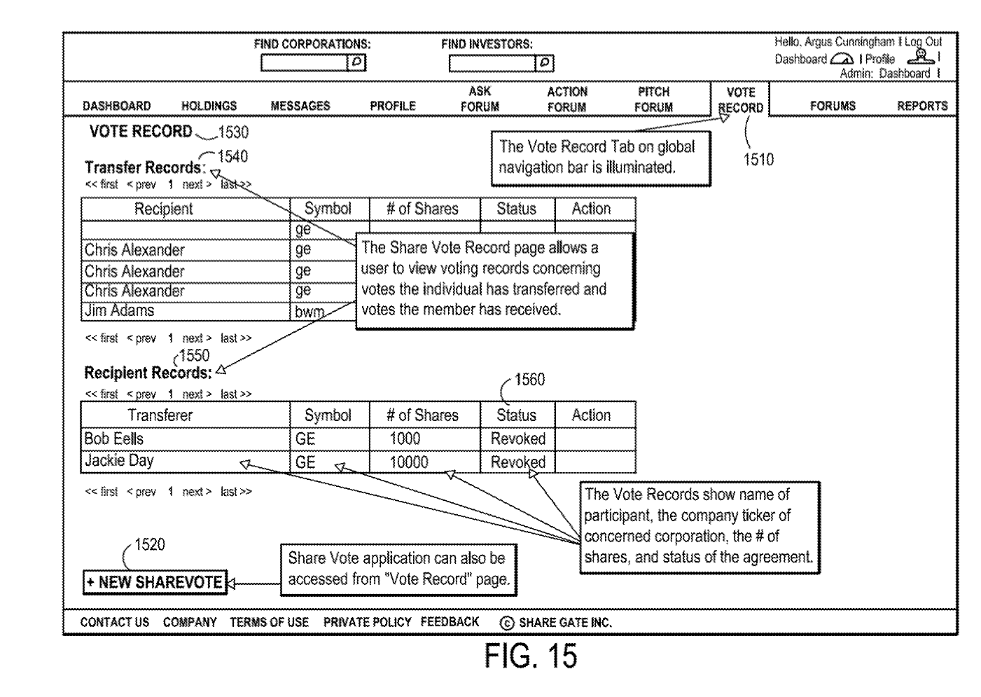

FIG. 15 is a diagrammatic illustration of an exemplary embodiment of a vote record display of the present disclosure. The initiating member's “Vote Record” tab 1510 allows the initiating member to view voting records 1530 of rights he has transferred 1540 and rights he has accepted 1550. In each case the status of the rights transfer is shown in a status window 1560. Additionally, a new voting rights reassignment process may be initiated from this page with the “New ShareVote” virtual button 1520.

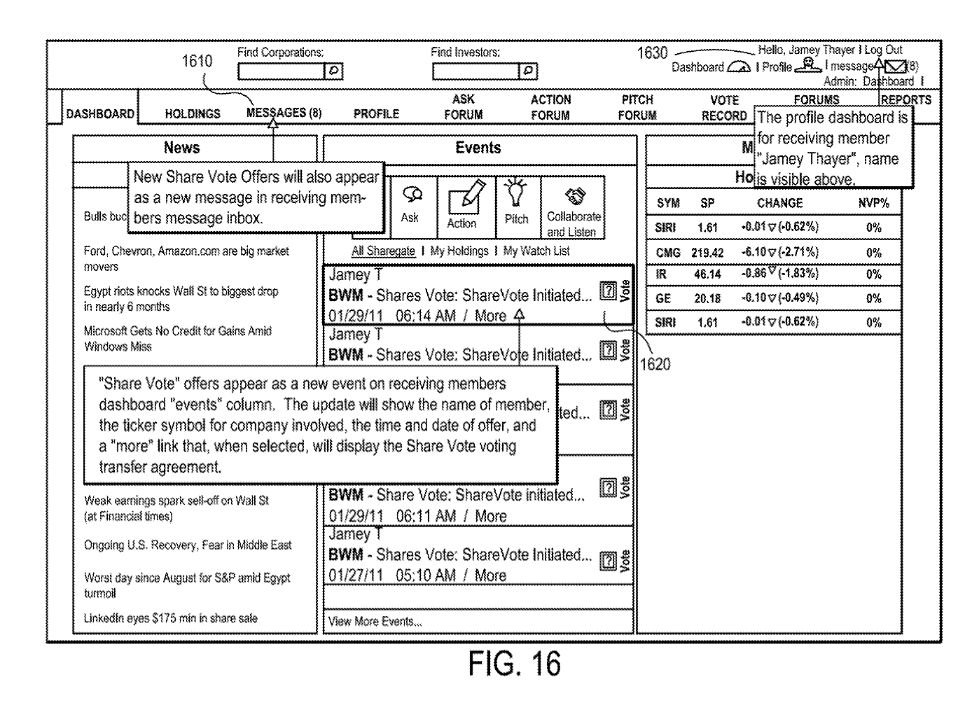

FIG. 16 is a diagrammatic illustration of an exemplary embodiment of an internet browser user interface dashboard of the present disclosure. The Global Navigation Bar displays that the recipient member (who accepted the voting rights transfer) has new messages 1610. Under the “Dashboard” tab, the center “Events” panel displays 1620 that he has been selected by another member who has offered to transfer rights to him. The dashboard further displays the members identity and other information 1630.

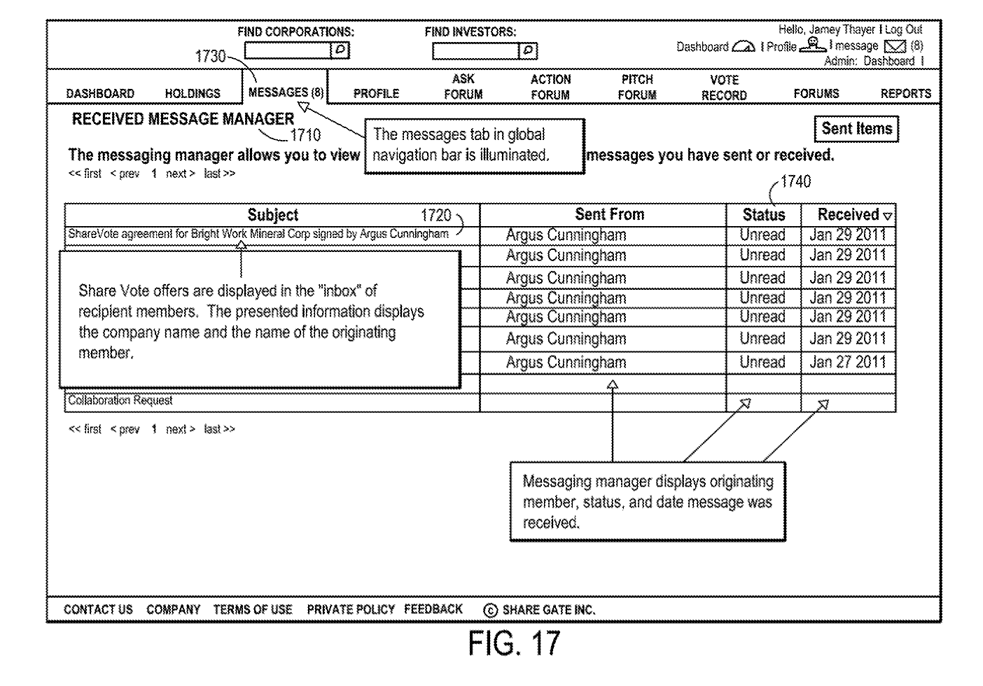

FIG. 17 is a diagrammatic illustration of an exemplary embodiment of an internet browser user interface for messages of the present disclosure. Continuing with the recipient's dashboard, opening messages tab 1730 opens message manager 1710. Share Vote offers 1720 are displayed by the message manager. The status of each offer is also displayed 1740.

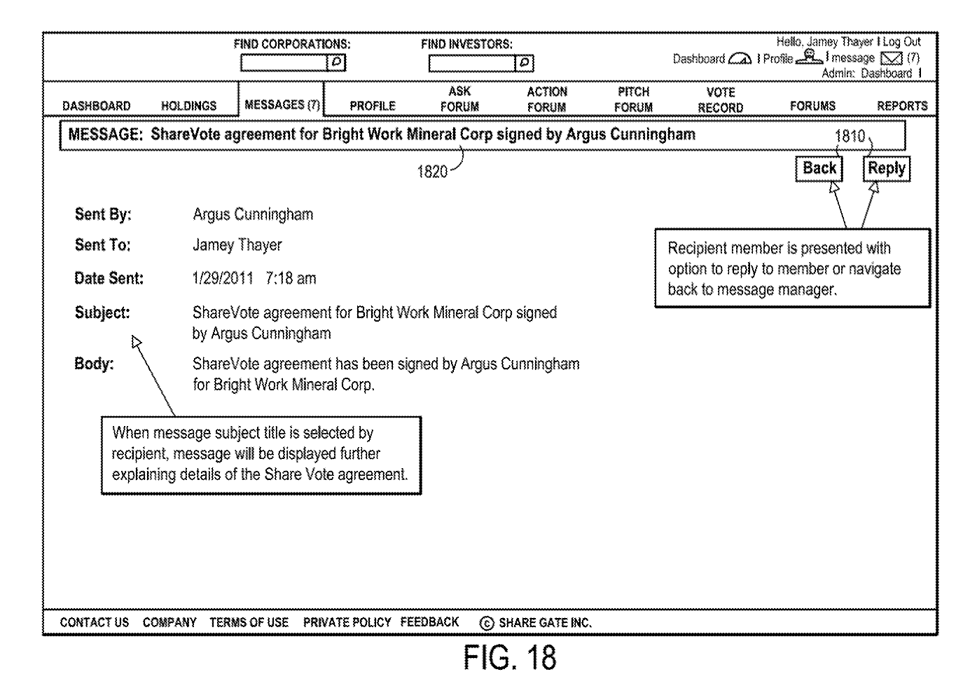

FIG. 18 is a diagrammatic illustration of an exemplary embodiment of an internet browser user interface for messages of the present disclosure showing a message for a voting reassignment agreement. When the recipient of the offer opens the message from the offeror, additional details about the offer are presented 1820. The recipient member may elect to reply to the message or to return to the message manger 1810.

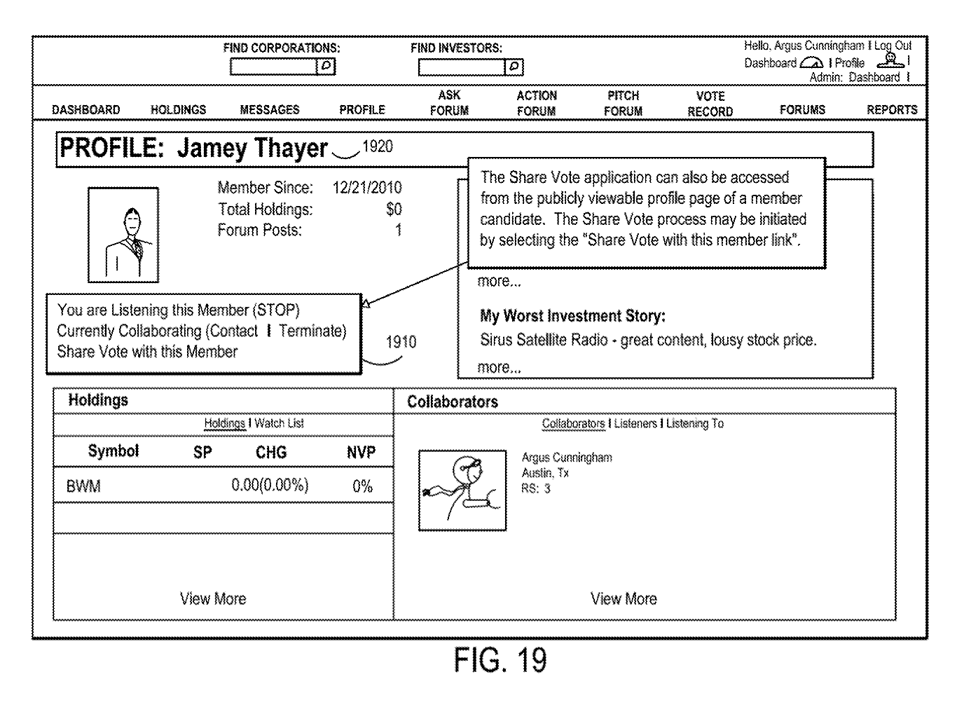

FIG. 19 is a diagrammatic illustration of an exemplary embodiment of an internet browser user interface profile page of the present disclosure. Yet another way to initiate a voting rights reassignment process is to access the application software 1910 from an intended recipient's profile page 1920. The initiating member is shown to be a collaborator on the intended recipient's profile.

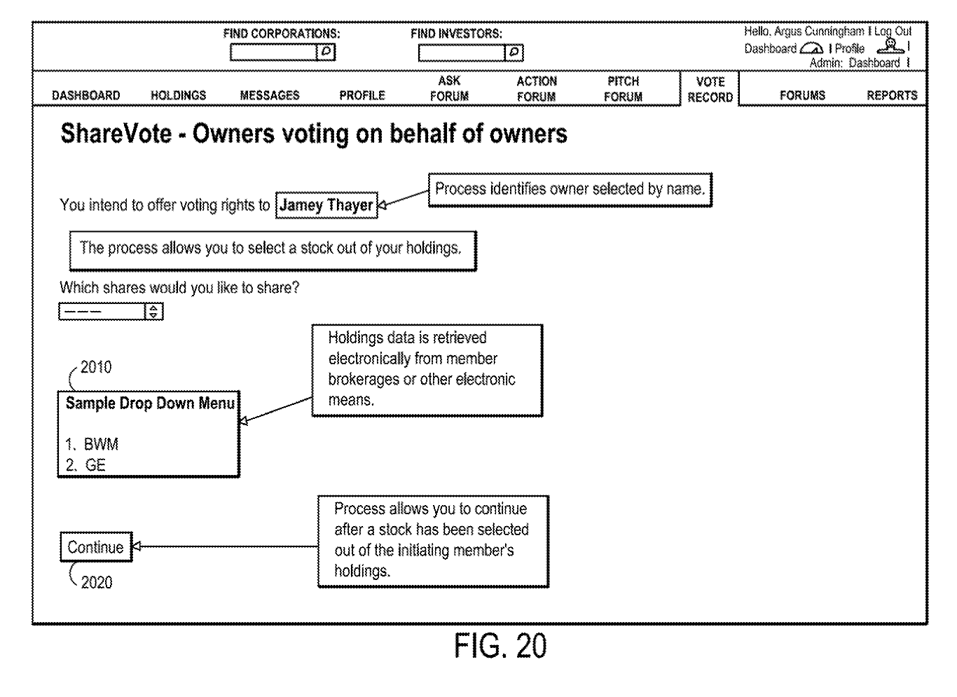

FIG. 20 is a diagrammatic illustration of an exemplary embodiment of a voting rights reassignment offer user interface of the present disclosure. Continuing from the FIG. 19, since the process is being initiated from member profile and not from the company profile (see FIG. 1), the initiating members selects the company whose share he wants to transfer voting rights in from a menu 2010. “Continue” 2020 advances the process to the next screen.

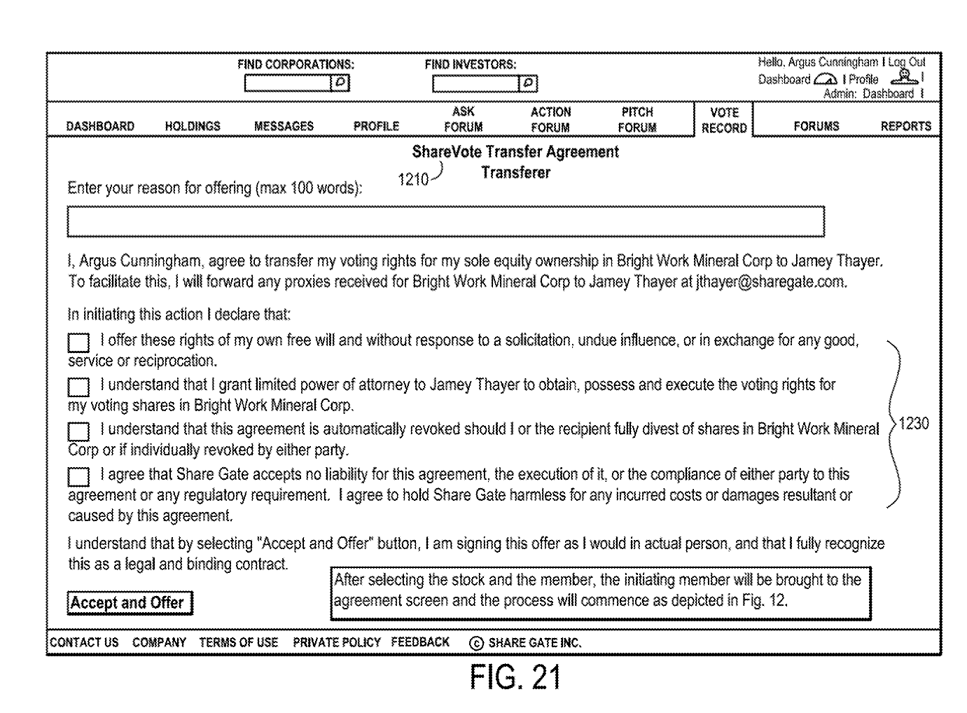

FIG. 21 is a diagrammatic illustration of an exemplary embodiment of an internet browser user interface for messages of the present disclosure showing a message for a voting reassignment agreement. Continuing from FIG. 20, with the recipient member and the company shares selected, an agreement is generated automatically as previously described for FIGS. 12 and 13.

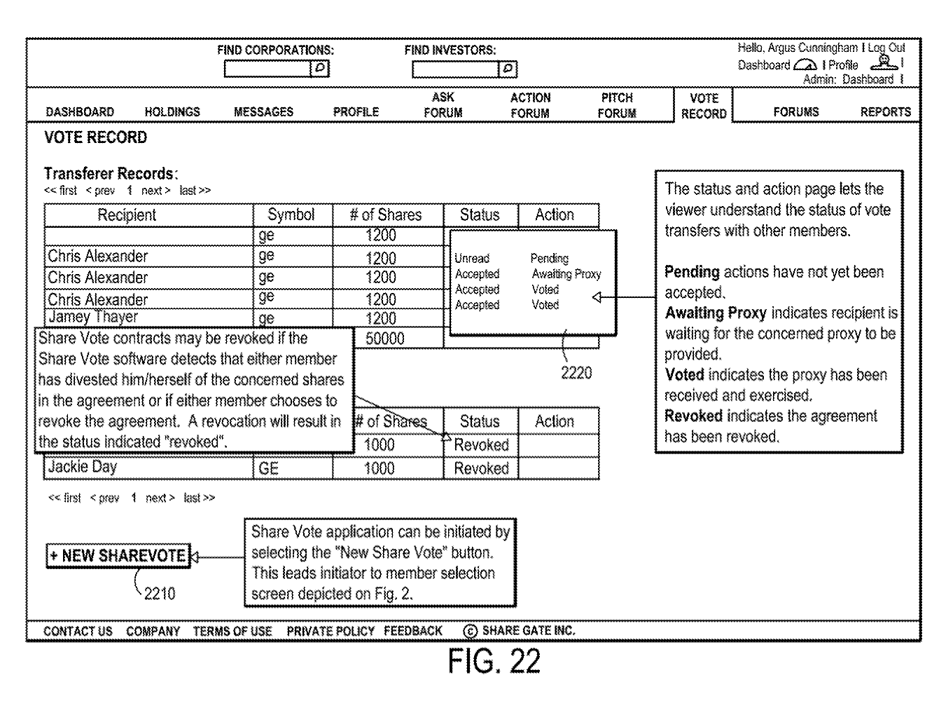

FIG. 22 is a diagrammatic illustration of an exemplary embodiment of an internet browser voting rights reassignment status page of the present disclosure. Returning to the initiating member's dashboard, the initiating member can view in the status window 2220 whether the intended recipient has accepted the offer. The member may initiate a new transfer of rights process with application launching virtual button 2210.

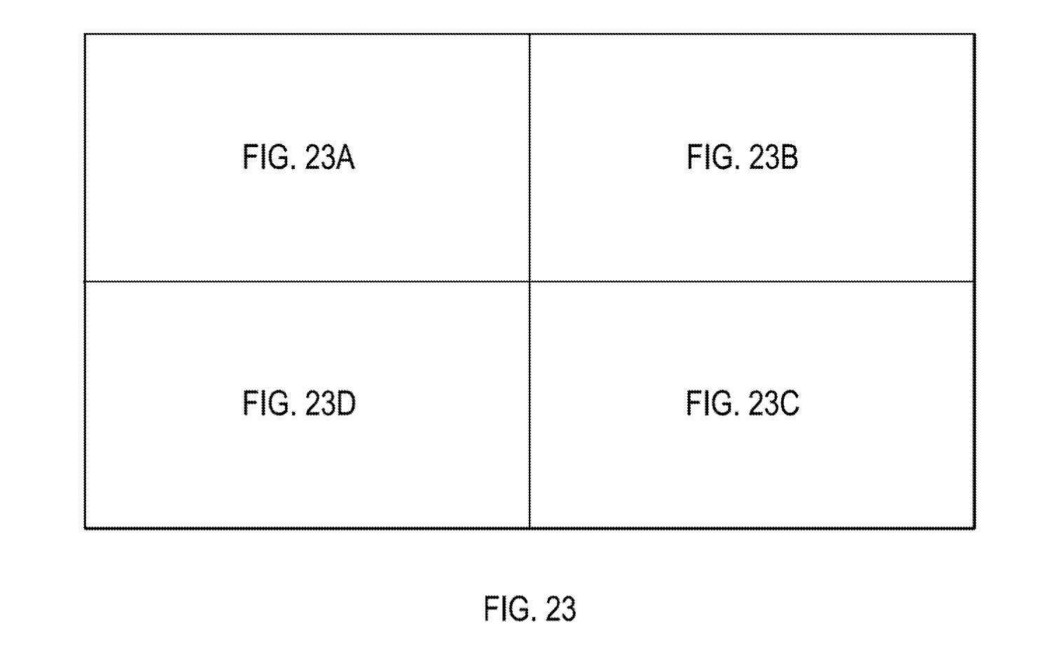

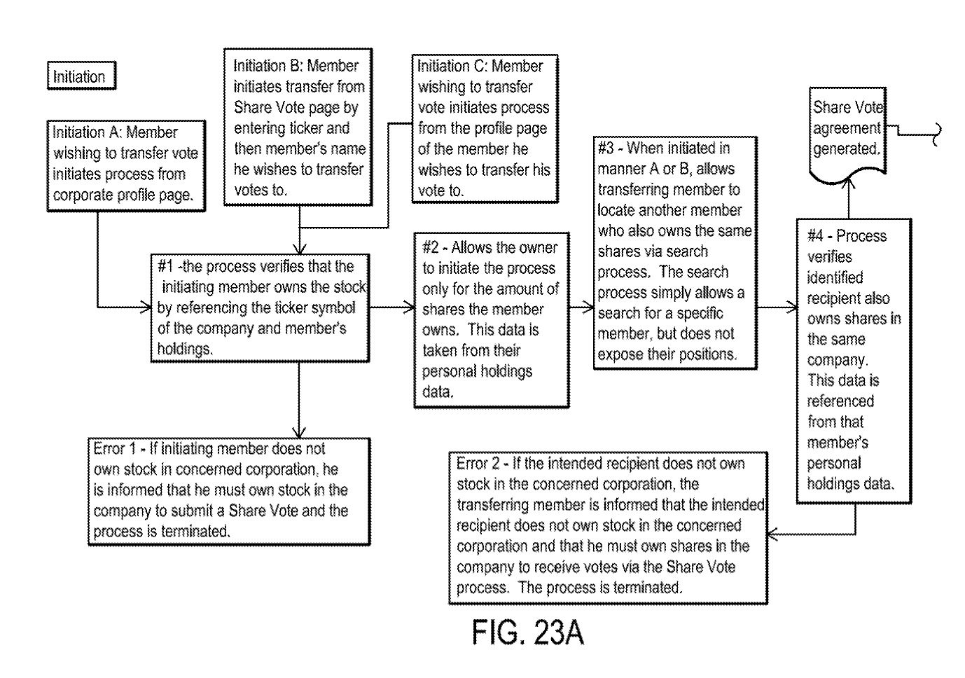

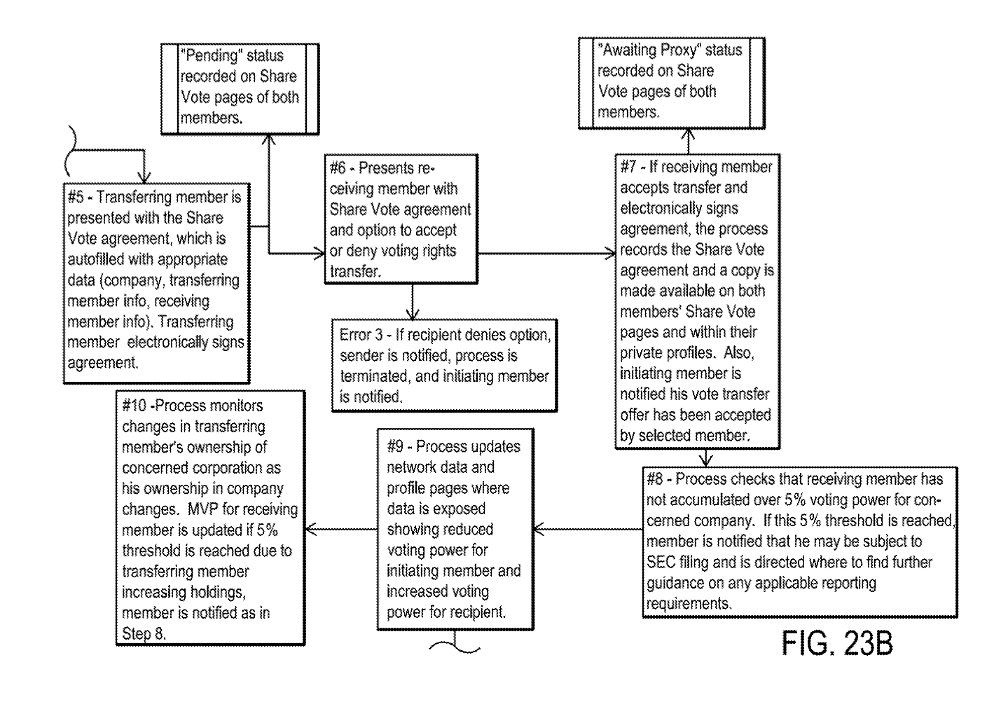

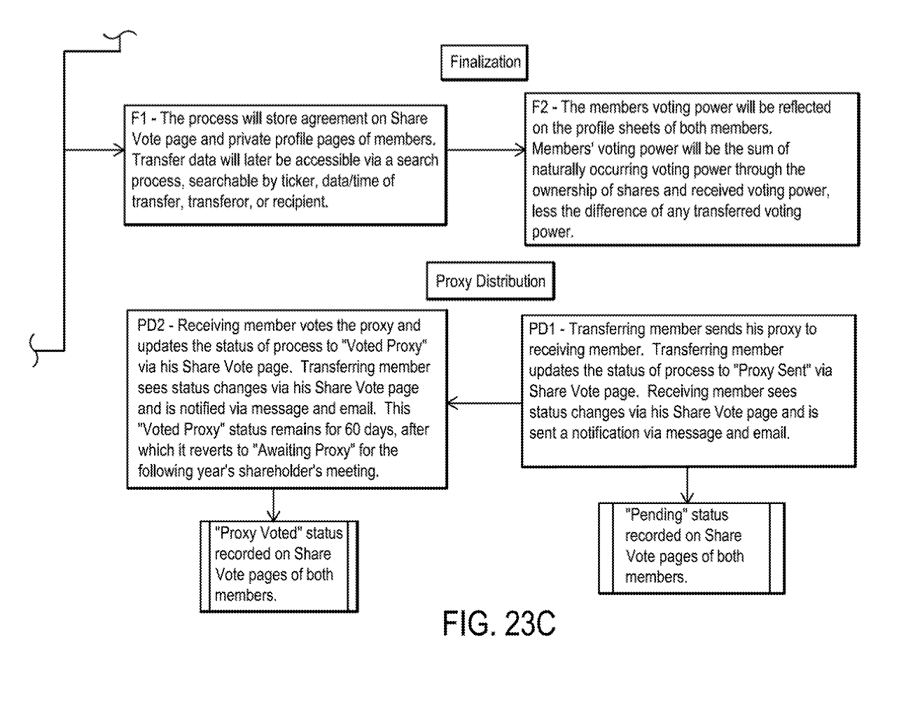

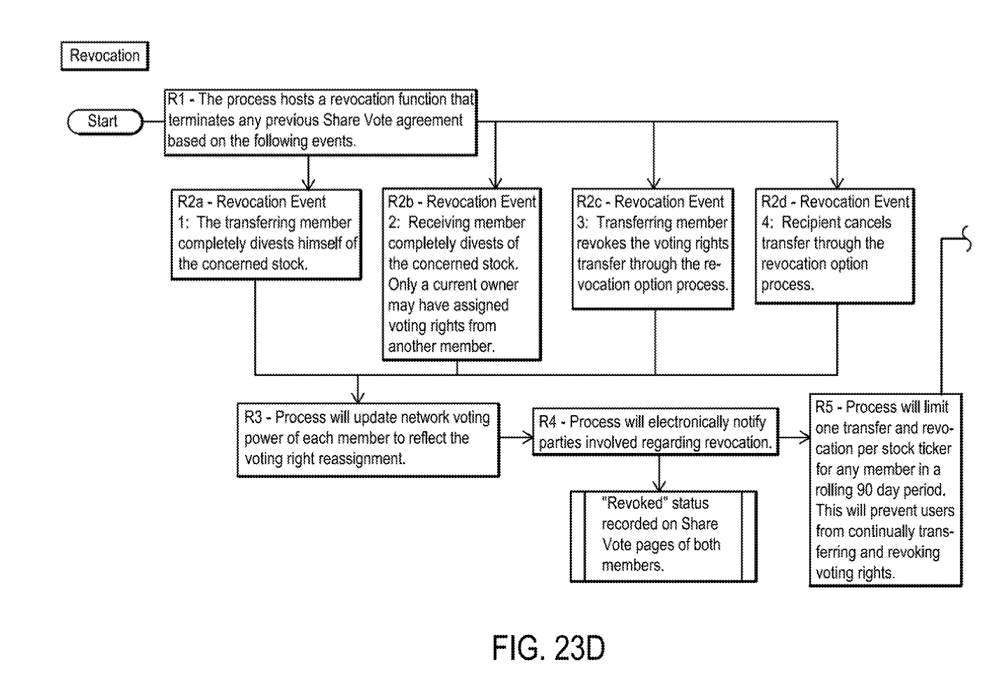

FIG. 23 is a diagrammatic map of FIGS. 23A-23D, each of which is a quadrant of a process flow chart of a voting rights reassignment method of the present disclosure. The method may be described as having several broad goals to attain: (1) Initiation, to initiate a reassignment of voting rights between shareholders by an initiating Network member and acceptance of the reassignment offer by a recipient member (FIGS. 23A and 23B); (2) Finalization of the rights reassignment, to document the transfer of rights, and notify the Network membership of the transfer (FIG. 23C); (3) Proxy Distribution, to put the transfer into effect (FIG. 23C); and (4) Revocation, to terminate or cancel the rights transfer (FIG. 23D).

FIG. 23A is a schematic process flow chart of a voting rights reassignment initiation method of the upper left quadrant of FIG. 23. Initiation of a right transfer proceeds as described about in FIGS. 1-22. An advantageous feature of the present method is that the software automatically checks whether the recipient member has accumulated over 5% of the company's outstanding shares, or what ever ownership threshold is in effect at that time. If the recipient has exceeded the threshold, the recipient member is automatically notified that regulatory requirements may apply to the transaction. The notice instructs the member where to find additional information. Specific alternative embodiments automatically update the threshold in response to applicable statutes or regulations.

FIG. 23B is a continuation of the schematic process flow chart of a voting rights reassignment initiation method of the upper right quadrant of FIG. 23. The initiating member is presented with an automatically generated agreement for the transfer of voting rights. The recipient has the option to accept or reject the agreement/offer. If the recipient accepts the agreement, the software automatically confirms that the recipient is qualified to receive the voting rights and automatically updates the status of the recipient on the website. The system automatically updates the voting power status of the recipient. The profiles of the initiating and recipient members are automatically updated and both members are notified by email and profile messages that the transfer was accomplished.

FIG. 23C is a schematic process flow chart of a voting rights reassignment finalization method and proxy distribution of the lower right quadrant of FIG. 23. Finalization of the transfer involves without limitation saving the transfer agreement electronically. Finalizing the offer and acceptance of the transfer creates a proxy which may be voted by the recipient during a shareholder meeting. The transfer data becomes searchable by Network members. Voting power is reflected in the on the profiles of both members, although specific alternative embodiments of the system provide a privacy feature so that voting power or other elements of a member's status may be kept private from non-authorized members.

Continuing with FIG. 23C, proxy distribution involves without limitation the initiating or transfer member sending the proxy to the recipient member. After the proxy is sent, the status of the transferring member is updated to display “Proxy Sent.” The recipient member receives a notice on his or her profile page and also by email that they have received the proxy. The Status on the transferring member's and the recipient member's profile displays “Proxy Pending,” for example.

The recipient votes the proxy. The status of the recipient is updated to display “Voted Proxy.” The transfer member is so notified by email, and may also see the status change on his profile page. Specific embodiments provide that the “Voted Proxy” status displays on profile page of the transferring member and the recipient member for 60 days, after which period the status automatically changes to “Awaiting Proxy,” for example on both profiles for the following year's shareholder meeting.

FIG. 23D is a schematic process flow chart of a voting rights reassignment revocation method of the lower left quadrant of FIG. 23. Revocation occurs when some step of the method fails and the reassignment of voting rights is terminated before finalization. Revocation is triggered, for example, when the system detects (1) that the initiating member does not own any shares of the company for which the member is attempting to reassign rights; (2) that the recipient member does not own any shares of the company for which initiating member attempts to reassign rights; (3) that the initiating member has revoked the transaction through a revocation option; and (4) that the recipient member cancels the offer through a revocation option. Furthermore, specific embodiments provide that only one transfer of rights may occur in each ninety (90) day period, for example, to prevent members from continually offering and revoking transfers of voting rights.

Revocation status is updated on all relevant profile pages and the appropriate members are notified by email.

In addition to the foregoing embodiments, the present disclosure provides a system that includes without limitation a website hosted on at least one server connected to the World Wide Web and a Network of shareholder website members, wherein at least one server hosting the website comprises a processor and a computer readable memory unit coupled to the processor, said memory unit containing program code configured to be executed by the processor to implement a method for conducting a shareholder action among shareholders of a company in an online Network.

In specific embodiments, the methods of the present disclosure are executed at least in part with the use of programs stored on machine readable medium to operate computers and devices according to the principles of the present disclosure. Machine readable media include, but are not limited to, magnetic storage medium (e.g., hard disk drives, floppy disks, tape, etc.), optical storage (CD-ROMs, optical disks, etc.), and volatile and non-volatile memory devices (e.g., EEPROMs, ROMs, PROMs, RAMs, DRAMs, SRAMs, firmware, programmable logic, etc.), server hard drives, thumb drives, also called memory sticks and the like. Furthermore, machine readable media include transmission media (network transmission line, wireless transmission media, signals propagating through space, radio waves, infrared signals, etc.) and server memories. Moreover, machine readable media includes many other types of memory too numerous for practical listing herein, existing and future types of media incorporating similar functionally as incorporate in the foregoing exemplary types of machine readable media, and any combinations thereof. The programs and applications stored on the machine readable media in turn include one or more machine executable instructions which are read by the various devices and executed. Each of these instructions causes the executing device to perform the functions coded or otherwise documented in it. Of course, the programs can take many different forms such as applications, operating systems, Perl scripts, JAVA applets, C programs, compilable (or compiled) programs, interpretable (or interpreted) programs, natural language programs, assembly language programs, higher order programs, embedded programs, and many other existing and future forms which provide similar functionality as the foregoing examples, and any combinations thereof.

Additionally, the present disclosure contemplates the present methods, system and software applications adapted for mobile devices such as smart phones and tablet computers that utilize software “apps” in which, for example, the user interface and displays of the present system are configured for portable devices with relatively small screens.

Many modifications and other embodiments of the methods and systems described herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for reassigning shareholder voting rights among members of an online shareholder Network from an initiating member of the Network to a recipient member of the Network, the method comprising:
selecting a company in whose shares the initiating member wishes to assign the initiating member's voting rights to the recipient member of the Network who also owns shares in the company;
selecting a Network member recipient to whom to offer the voting rights;
initiating an offer to transfer voting rights to the selected member,
finalizing the transfer of voting rights in the form of a proxy, and
distributing the proxy to the recipient to increase the voting power of the recipient and decrease the voting power of the initiating member in the company.

2. The method of claim 1, further comprising revoking the offer prior to finalizing the transfer of rights.

3. The method of claim 2, wherein revoking the offer is automatic if one or more pre-defined condition is met.

4. The method of claim 1, further comprising automatically generating an agreement that is entered into by the initiating member and the recipient member prior to finalizing the transfer of rights.

5. The method of claim 1, further comprising providing a website hosted on at least one server connected to the Internet, and a Network of shareholder website members, wherein at least one server hosting the website comprises a processor and a computer readable memory unit coupled to the processor, said memory unit containing program code configured to be executed by the processor to at least partially automate one or more of the steps of the method.

6. The method of claim 5, further comprising updating the status of the voting rights in the company automatically on the website.

7. The method of claim 1, further comprising voting the proxy by the recipient.

8. The method of claim 1, further comprising restoring the transferred voting rights to the initiating member after a pre-determined amount of time.

9. The method of claim 1, further comprising prohibiting the initiating member from initiating another reassignment for a pre-determined amount of time after a successful reassignment of voting rights.

10. A system to reassign voter rights among shareholders of a company in an online Network, the system comprising a website hosted on at least one server connected to the World Wide Web and a Network of shareholder website members, wherein at least one server hosting the website comprises a processor and a computer readable memory unit coupled to the processor, said memory unit containing program code configured to be executed by the processor to implement a method to reassign voter rights among shareholders of a company by a user in an online Network, the method comprising:
accepting user input to select a company in whose shares an initiating member wishes to assign the initiating member's voting rights to a recipient member of the Network who also owns shares in the company;
accepting user input from the initiating member to select a Network member recipient to whom to offer the voting rights;
accepting user input from the initiating member to initiate an offer to transfer voting rights to the selected recipient member,
automatically finalizing the transfer of voting rights from the initiating member to the recipient member in the form of a proxy, and
automatically distributing the proxy to the recipient to increase the voting power of the recipient and decrease the voting power of the initiating member in the company.

11. The system of claim 10, further comprising accepting user input to revoke the offer prior to finalizing the transfer of rights.

12. The system of claim 11, wherein revoking the offer is automatic if one or more pre-defined condition is met.

13. The system of claim 10, further comprising automatically generating an agreement that is entered into by the initiating member and the recipient member prior to finalizing the transfer of rights.

14. The system of claim 10, further comprising automatically updating the status of the voting rights in the company on the website.

15. The system of claim 10, further comprising automatically restoring the transferred, voting rights to the initiating member after a pre-determined amount of time.

16. The method of claim 10, further comprising automatically prohibiting the initiating member from initiating another reassignment for a pre-determined amount of time after a successful reassignment of voting rights.
